(19) United States
(12) Patent Application Publication
(10) Pub. No.: US 2014/0363590 A1
(43) Pub. Date: Dec. 11, 2014

(54) Inflatable fabric decoration

(71) Applicant: Tracey Lynn Gianakas, Bayport, NY (US)

(72) Inventor: Tracey Lynn Gianakas, Bayport, NY (US)

(21) Appl. No.: 14/299,946

(22) Filed: Jun. 9, 2014

Related U.S. Application Data
(60) Provisional application No. 61/833,071, filed on Jun. 10, 2013.

(51) Int. Cl. B44C 5/00

(52) U.S. Cl. CPC B44C 5/005; B44C 5/00
USPC 428/12

(57) ABSTRACT

A fabric decoration comprised of an outer casing of material having a slit opening, and a trim material attached to either side of the slit opening. The outer casing is composed of a textured or layered material, where layered is comprised of a base material on which one or more other materials are attached by some means, like embroidery, creating a material with more depth than the base material. The outer casing encapsulates a balloon of stretchable material having an air passage stem, which when unconfined is capable of being inflated to assume the predetermined shape of the outer casing. In its deflated state, the balloon is inserted into the outer casing through the slit opening. The trim material on either side of the slit opening can be used for various display purposes.

### BACKGROUND OF INVENTION

1. Field of the Invention

The decoration is transformed from a deflated state enabling the fabric decoration to lay generally flat (for easy shipping, storage and sale) into a full bodied, fanciful, eye-catching decoration. When laid on a flat surface (for shipping and storage), the decoration consumes a minimum of space in that it rests generally flat. The decoration is re-usable by deflating the balloon, removing the balloon and replacing it with another balloon as needed. When the decoration is expanding by inflation, after purchase by the consumer, the trim material can be used for various purposes, such as concealing the slit, concealing the balloon, anchoring the decoration, or decorative purposes.

2. Description of Related Art

Decorations are often used to adorn walls and ceilings during events or as decor. Some of the conventional hanging decorations are made from paper or balls formed of live flowers, such as modern day pomanders. This aspect means that they are not made to last or able to reuse. There are, of course, spherical hanging decoration balls formed of artificial flowers. These, however, are already provided to the consumer in their final size and/or shape and are not easily stored or maintainable. The present invention, is re-usable, and provides the visual appearance, with the textured or fabric with depth used, of a fanciful decoration. Another object of the present invention is to provide a full bodied decoration which is easy and efficient to ship and store. It is shipped and stored generally flat yet quickly assumes a full bodied shape upon inflation by the consumer. Upon inflation, which is merely the process of the consumer inflating the balloon into the outer casing, results in an eye-catching and visual pleasing decoration.

### SUMMARY OF INVENTION

An object of the present invention is to provide a decoration, comprised of an textured or layered fabric casing, a balloon of stretchable material having an air passage stem, and attached trim material for concealing the slit, concealing the balloon, anchoring the decoration, or decorative purposes. The decoration lays generally flat for efficient shipping and storage. When the decoration is inflated the outer casing material assumes a predetermined shape and size as part of the decoration. The invention also provides a reusable decoration by deflating, inflating, or replacing the balloon of stretchable material as needed.

### DRAWING KEY

10—Outer casing

### 11—Balloon

12—Slit opening in outer casing
13A—Right side of slit
13B—Left side of slit
14A—Right side trim material
14B—Left side trim material

### DRAWING DETAILS

Other advantages and novel features of the invention will become more apparent from the following detailed description taken in conjunction with the accompanying drawings from one example embodiment of the invention.

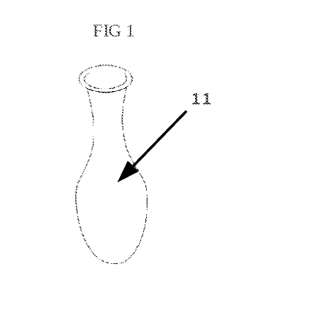

FIG. 1. Balloon 11 in deflated state

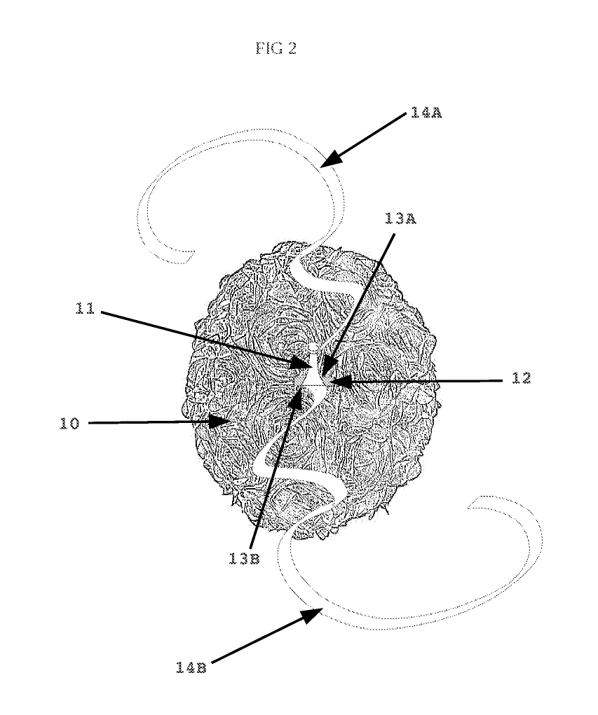

FIG. 2. Top view of deflated state of the fabric decoration. The balloon 11 is inserted between right side of outer casing slit 13A and left side of outer casing slit 13B into slit opening 12 on the outer casing 10. Balloon 11 air passage system is extended out of the slit opening 12 as prepared for inflation. Right side trim material 14A attached to right side of slit 13A, and left side trim material 14B, attached to left side of slit 13B, remain untied.

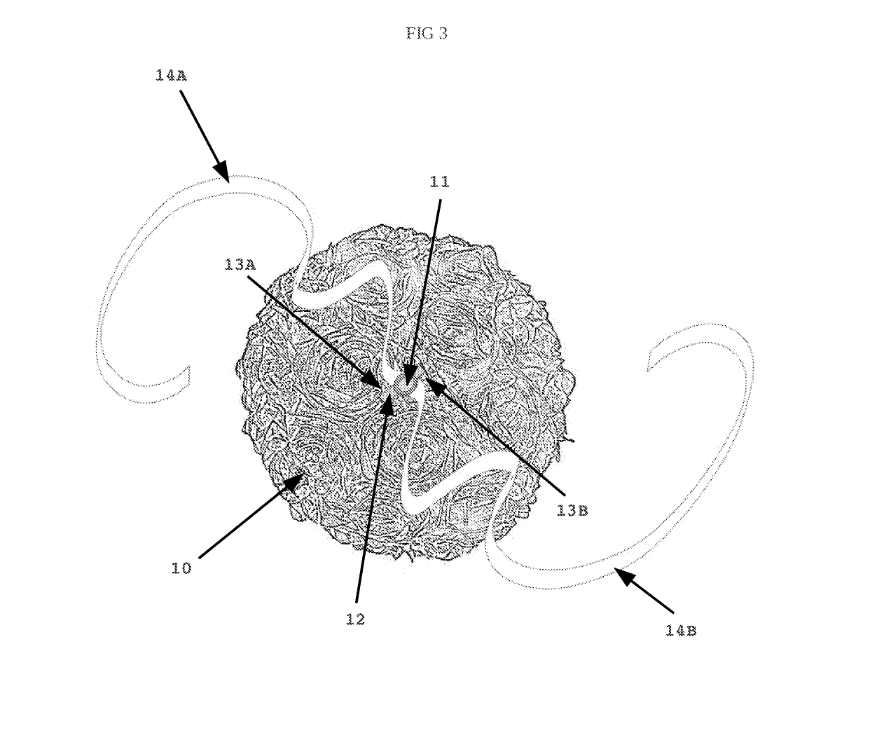

FIG. 3. Top view of deflated state of the fabric decoration. The balloon 11 is inflated and then the air passage stem is constricted to prevent deflation. The balloon nozzle can then be tucked into the slit opening 12 between right side of slit 13A and left side of slit 13B on the outer casing 10. Right trim material 14A attached to right side of slit 13A and left trim material 14B attached to left side of slit 13B remain untied.

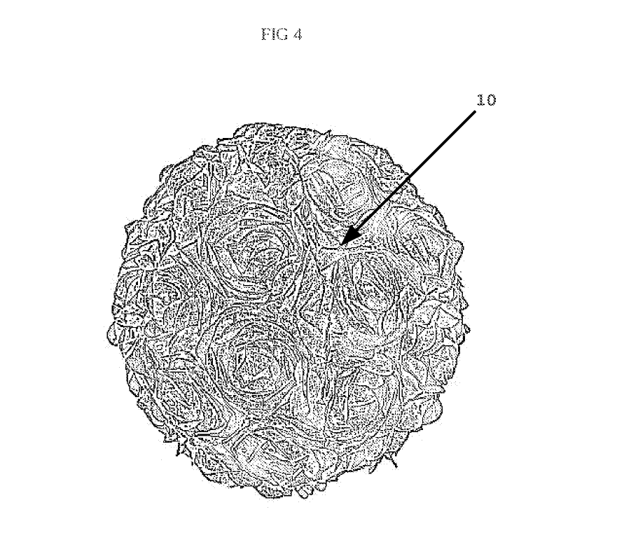

FIG. 4. Bottom view of inflated state of the fabric decoration outer casing 10 when suspended from above.

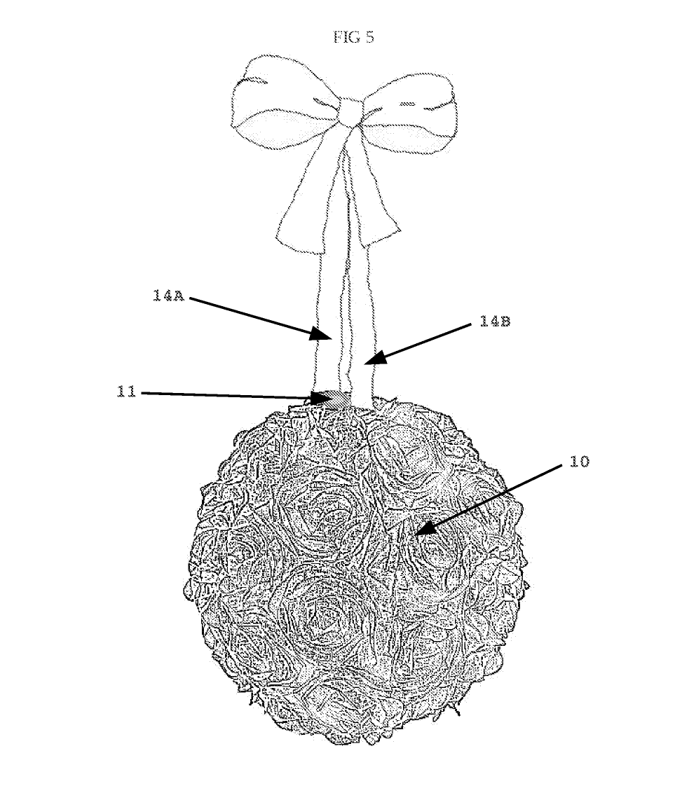

FIG. 5. Side view of the inflated state of the fabric decoration outer casing 10 when suspended from above. In one embodiment, a possible display option includes fastening the inflated fabric decoration from above with a pin or tape (not shown) or tying the right trim material 14A and left trim material 14B together directly above the slit opening where balloon 11 is concealed and hanging from above.

### DESCRIPTION OF INVENTION

A fabric decoration comprised of an outer casing of material having a slit opening, and a trim material attached to either side of the slit. The outer casing is composed of a textured or layered material, where layered is comprised of a base material on which one or more other materials are attached by some means, like embroidery, creating a material with more depth than the base material. The outer casing encapsulates a balloon which is an air tight stretchable material having an air passage stem, which when unconfined is capable of being inflated to assume the predetermined shape of the outer casing. In its deflated state, the balloon is inserted into the outer casing through the opening created by the slit, with the balloon stem projecting out of the slit. The confined balloon is inflated causing the outer casing to assume a predetermined shape. The balloon air passage stem is then constricted to prevent deflation. The trim material on either side of the slit can be used for various purposes, such as concealing the slit, concealing the balloon, anchoring the decoration, or decorative purposes.

I claim:

1. An inflatable decoration comprising: the main body portion of an outer casing formed of textured or layered material which assumes a spherical shape when expanded, the outer casing having a slit opening and trim attached to either side. A removable balloon formed of an elastic material is inserted in the slit opening; wherein the balloon is inflated resulting in the expansion of the outer casing.

2. The inflatable decoration as claimed in claim 1, wherein the slit opening the balloon is inserted.

3. The inflatable decoration as claimed in claim 1, wherein the balloon is inflated after insertion through slit opening.

4. The inflatable decoration as claimed in claim 1, wherein the balloon is knotted after inflation.

5. The inflatable decoration as claimed in claim 1, wherein the main body portion can be displayed using the said trim.
